(19) United States
(12) Patent Application Publication
(10) Pub. No.: US 2015/0178666 A1
(43) Pub. Date: Jun. 25, 2015

(54) SYSTEM AND METHOD FOR MANAGING CONCURRENT STEPS IN PROCESSES AND COMMUNICATING STEP ATTRIBUTES TO PROJECT MEMBERS

(71) Applicants: Brian Joseph Green, Murrieta, CA (US); John Russell Gravett, Wildomar, CA (US)

(72) Inventors: Brian Joseph Green, Murrieta, CA (US); John Russell Gravett, Wildomar, CA (US)

(21) Appl. No.: 14/571,542

(22) Filed: Dec. 16, 2014

Related U.S. Application Data
(60) Provisional application No. 61/918,572, filed on Dec. 19, 2013.

(51) Int. Cl. G06Q 10/06

(52) U.S. Cl. CPC G06Q 10/063114

(57) ABSTRACT

Some embodiments include a novel system for managing concurrent steps in processes and communicating step attributes to project members. In some embodiments, the system includes a process that is implemented as a software application which each member of a project uses in managing and completing the project. In some embodiments, the software application accesses a web page to allow immediate connections and updates to the project by a mobile communication device app for the project. In some embodiments, updates are automatically pushed to one or more project members.

### CLAIM OF BENEFIT TO PRIOR APPLICATION

This application claims benefit to U.S. Provisional Patent Application 61/918,572, entitled “SYSTEM AND METHOD FOR MANAGING CONCURRENT STEPS IN PROCESSES AND COMMUNICATING STEP ATTRIBUTES TO PROJECT MEMBERS,” filed Dec. 19, 2013. The U.S. Provisional Patent Application 61/918,572 is incorporated herein by reference.

### BACKGROUND

Embodiments of the invention described in this specification relate generally to project management, and more particularly, to communication between project members.

Projects or processes with multiple steps often rely on someone else (i.e., other departments, other companies, other people or subcontractors, etc.) to complete a step before the next step can start. This causes communication issues and inefficiencies in the process.

Processes currently use paper as a way of tracking the progress of a project. Often key personnel may have different revisions of the project processes or when a step of the process is ready to start, the responsible party cannot be found in a timely manner.

By moving this to a web page/phone app, updates will happen immediately. Parties will not have to be close by to get updates on when tasks are completed. Updates will be pushed to the phones of parties working on the project for immediate review. Others could see updates in a slightly delayed manner while seated at a desktop computer.

Therefore, what is needed is a way to manage concurrent steps in project processes and quickly and efficiently communicate process step attributes to project members.

### BRIEF DESCRIPTION

Some embodiments of the invention include a novel system for managing concurrent steps in processes and communicating step attributes to project members. In some embodiments, the system includes a process that is implemented as a software application which each member of a project uses in managing and completing the project.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now made to the accompanying drawings, which are not necessarily drawn to scale, and which show different views of different example embodiments, and wherein:

FIG. 1 conceptually illustrates a step management process in some embodiments.

FIG. 2 conceptually illustrates an account view in a graphical user interface (GUI) of a software application that implements the step management process in some embodiments.

FIG. 3 conceptually illustrates a creation view in a GUI of a software application that implements the step management process in some embodiments.

FIG. 4 conceptually illustrates a new task creation tool in a GUI of a software application that implements the step management process in some embodiments.

FIG. 5 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel system for managing concurrent steps in processes and communicating step attributes to project members. In some embodiments, the system includes a process that is implemented as a software application which each member of a project uses in managing and completing the project. In some embodiments, the software application accesses a web page to allow immediate connections and updates to the project by way of a computing device running project-related software (e.g., a mobile computing/communication device running a mobile app for the project). In some embodiments, updates are automatically pushed to computing devices of one or more project members.

As stated above, projects or processes with multiple steps often rely on someone else (i.e., other departments, other companies, other people or subcontractors, etc.) to complete a step before the next step can start. This causes communication issues and inefficiencies in the process. Embodiments of the invention described in this specification solve such problems by allowing a project manager to input all the tasks or steps of a project into a web site where all tasks can be tracked by start and finished time, updating selected parties once completed. Alerts can then be sent to assigned parties (e.g., an email alert sent to a smart phone of the project manager, an alert sent to all project members, etc.). Updates can also be emailed on completion of tasks or the conclusion of the project outlining how long each task took to complete and if they were on target with completion time.

The embodiments described in this specification differ from and improve upon currently existing options. In particular, some embodiments differ by ensuring that all parties responsible for the management or completion of a project with processes are communicated electronically and the current process revision is communicated to all. This also allows for tracking of key attributes that cannot be done easily with paper.

In addition, these embodiments improve upon the currently existing options which create communication issues and often result in time wasted and man-power inefficiencies. By moving this to a web page/phone app updates will happen immediate. Parties will not have to be close by or by a phone to get updates on when tasks are completed. Updates will be pushed to parties working on the project, regardless of the type of computing device they use.

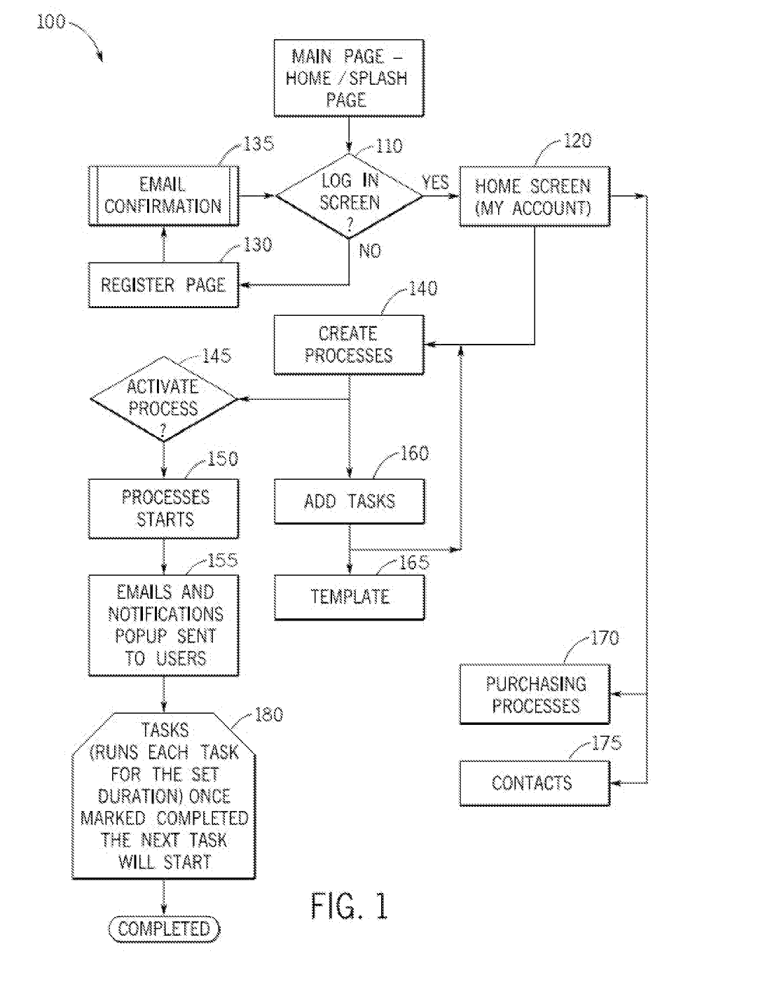

By way of example, FIG. 1 conceptually illustrates a step management process 100 for managing concurrent steps in some embodiments. The steps of the process 100 in some embodiments are performed by a step management software application. The steps of the process 100 are intended to be exemplary only and it is not intended that this list be used to limit the step management process 100 to just these steps. Persons having ordinary skill in the art relevant to the present disclosure may understand there to be equivalent steps that may be substituted within the present disclosure without changing the essential function or operation of the step management process 100.

In some embodiments, the step management process 100 begins when a user accesses a main web page over the Internet with a computing device (e.g., smartphone, tablet computing device, laptop or desktop computer, etc.). In some embodiments, the step management process 100 first determines (at 110) whether to display a log in screen. For example, the main web page may initially prompt the user to logon to the web page. When the logon screen is not displayed, the step management process 100 displays (at 130) a user registration page. By displaying the registration page, the user can then register for a new account. The step management process 100 then transmits (at 135) an email confirmation of the user registration. On the other hand, if the step management process 100 displays the logon screen (at 110), then in some embodiments, the step management process 100 displays (at 120) a home screen for an account associated with the user (e.g., “my account home screen”). In some embodiments, the home screen is presented to the user as an account view in a graphical user interface (GUI) of a software application.

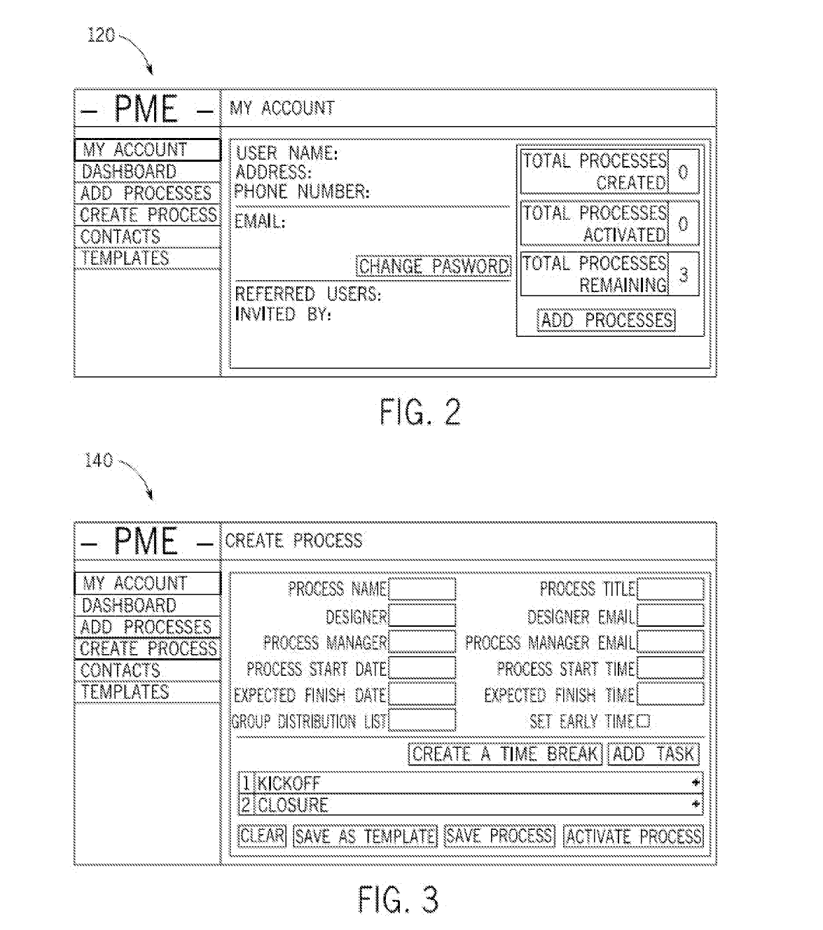

By way of example, FIG. 2 conceptually illustrates an account view 120 in a GUI of a software application that implements the step management process 100 in some embodiments. As shown in this figure, the account view 120 (i.e., “MY ACCOUNT”) provides several selectable menu tools, including “My Account”, “Dashboard”, “Add Processes”, “Create Process”, “Contacts”, and “Templates”. In some embodiments, this set of selectable menu tools are displayed in several different views of the GUI. For instance, the same set of menu tools may be displayed in a process creation view of the GUI when the user selects the option to “Create Process”. In the account view 120, however, a specific window frame is displayed in the lower right quadrant of the account view 120. The window frame displays several fields of personal account information, including (in this example) “User Name”, “Address”, “Phone Number”, “Email”, Referred Users”, and “Invited By”. Additionally, a “Change Password” button is displayed which allows the user to change his or her account password. Also, a summary of project/process data is displayed in relation to the user associated with the displayed account view 120, including “Total Processes Created”, “Total Processes Activated”, and “Total Processes Remaining”, along with a button to “Add Processes”.

Referring back to FIG. 1, after the step management process 100 displays (at 120) the home screen and all the details related to the user's account information and project/process summary, the process 100 may then transition to 170 to perform purchasing process (at 170) and then to 175 to user contacts (at 175). On the other hand, the step management process 100 may transition from the home screen (at 120) to operations that create processes (at 140). For example, if the user is viewing the account information in the home screen 120, and then selects the menu tool to “Create Process”, the step management process 100 would then transition to 140 to create the process. In some embodiments, the step management process 100 performs several process-related operations (which are described in further detail below) to create the process. One or more of the operations may be completed by the step management process 100 which may create processes (at 140) through a graphical user interface (GUI) of a software application.

By way of example, FIG. 3 conceptually illustrates a project/process creation view 140 in a GUI of a software application that implements the step management process 100 in some embodiments. As shown in this figure, the project/process creation view 140 (i.e., “CREATE PROCESSES”) provides the same set of menu tools as the account view 120 described by reference to FIG. 2. Similarly then, the user is able to select any of the menu tools from within the project/process creation view 140 in order to perform any of several operations. For instance, the user may select “My Account” in order to transition back to the home screen to display the account view 120 of the GUI. However, the user may also have selected to create a process, and therefore, may wish to complete the process creation using the tools and options available from the project/process creation view 140. In particular, the project/process creation view 140 displays process information, including “Process Name”, “Designer”, “Process Manager”, “Process Start Date”, Expected Finish Date“, “Group Distribution List”, “Process Title”, “Designer Email”, “Process Manager Email”, “Process Start Time”, “Expected Finish Time”, and a check-box option to “Set Early Time”. Additionally, the project/process creation view 140 provides a button to “Create A Time Break” and a button to “Add Task”. A summary of the process is displayed on the bottom of the view. In this example, the summary displays “1—Kickoff” and “2—Closure”. Buttons are provided to “Clear”, “Save As Template”, “Save Process”, and “Activate Process”.

Referring back to FIG. 1, after the step management process 100 creates a process (at 140) through the project/process creation view 140 of the GUI, and all the details related to the project/process being created, the step management process 100 may then transition to 160 to add tasks (at 160) to the project/process. In some embodiments, the step management process 100 may add multiple tasks. For example, after adding a first task to the project/process, the step management process 100 may transition back to the project/process creation view 140 to allow for additional tasks and/or templates to the added to the project/process. Thus, the step management process 100 may also add create a template (at 165) when the user indicates that the project/process is to be saved as a template (e.g., by selection of the button to “Save As Template”). In some embodiments, the step management process 100 performs several iterations of templates in relation to multiple tasks. Typically, the tasks and/or templates are associated with the project/process through a graphical user interface (GUI) of a software application.

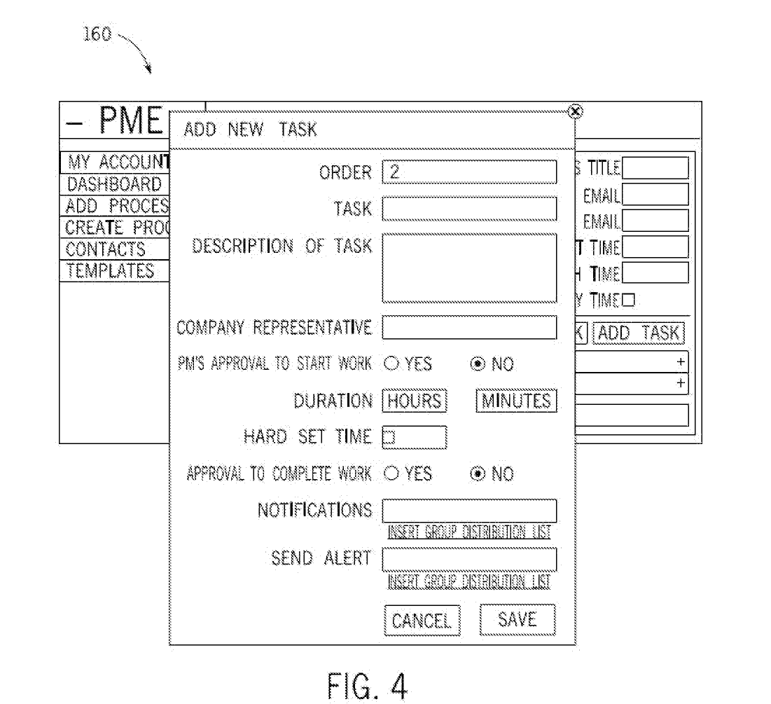

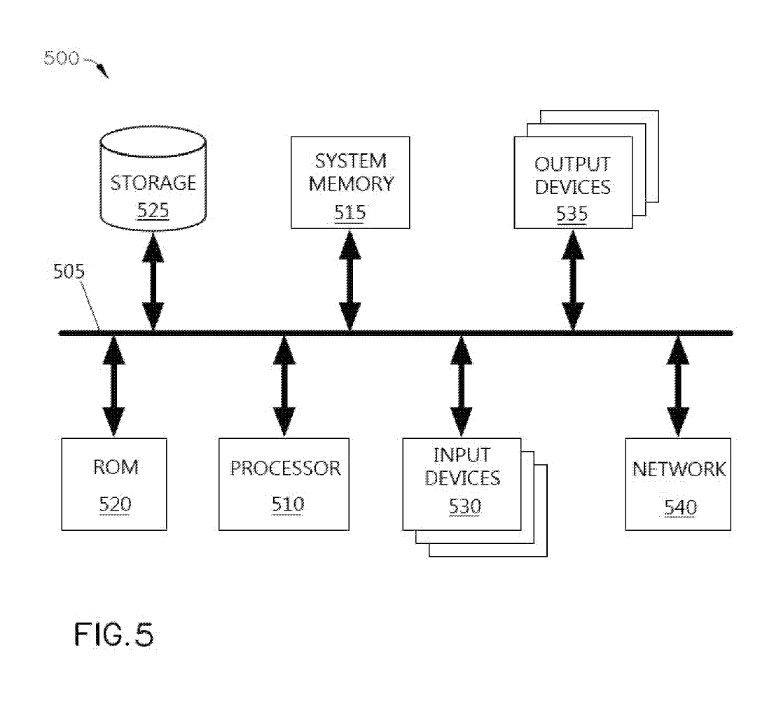

By way of example, FIG. 4 conceptually illustrates a new task creation tool 160 in a GUI of a software application that implements the step management process 100 in some embodiments. As shown in this figure, the new task creation tool 160 (i.e., “ADD NEW TASK”) provides a set of fields to add information related to the task. In this example, the fields allow the user to specify “Order”, “Task”, “Description of Task”, “Company Representative”, “PMS Approval to Start Work”, “Duration”, “Hard Set Time”, “Approval to Complete Work”, “Notifications”, and “Send Alert”. Additionally, buttons are provided to “Cancel” and “Save”.

Referring back to FIG. 1, after tasks and/or templates are completed for the project/process, or in the event that no tasks or templates are generated in relation to the project/process, the step management process 100 will then determine (at 145) whether to activate any process. For example, some processes that have been created are activated immediately upon creation, while other project/processes are activated at a specific time after creation. When a process is activated, the step management process 100 starts (at 150) the process or processes. Then the step management process 100 notifies users (at 155) via email and/or pop-up notifications that the processes are under way.

Finally, the step management process 100 iterates (at 180) through all of the tasks associated with each project/process until the task is completed (allowing for the next task to start). In some embodiments, the step management process 100 marks the project/process as completed and may send a final report out to one or more of the project/process team members and/or other interested parties specified as having report clearance. Moreover, in some embodiments, project/process data is pushed to smartphones and/or other computing devices. In this way, the step management process 100 completes each project/process.

In some embodiments, the web site is used to create the process steps. The web site then pushes data to phone apps or emails the data. Times that tasks are completed will be updated and change the start times of the following task. This repeats for the number of tasks. Once all tasks are completed and the project is marked completed a final report is emailed out.

The system of the present disclosure generally works with the web site allowing a user to input all process or steps for their project in a very simple straight forward way. By inputting all the data for the project (such as start date, start time, location, party's responsible, and notification alerts), and breaking this data out into steps or tasks, this software can keep large or small projects on point and moving along. It eliminates human error of verbal and written communications. Basically, the project steps are on each party's computing device (e.g., smartphone, tablet, desktop computer, etc.). As each step gets completed, notifications are sent to the project manager and other parties that need to be notified including the person required to start the next step or process. The software tracks the start and stop time of each step and keeps management notified of the projects current status and if the project is on schedule or not. Once the project is completed, detailed reports will be available to be emailed to those parties that require it.

When a task completed button is pressed, the software will check to see if project manager's approval is needed to start next task. The finished time for each task will be updated and the anticipated finish time of the project will be updated. It will also push notification out to party for that task or email them.

To make the system of the present disclosure, a website or software app would need to be created for the user to input the details of the project. An app for a computing device (e.g., smartphones, tablets, other mobile computing/communication devices, desktop computers, servers, etc.) would need to be written to allow personnel to update each step of the project and for management to get updates via push notifications. The app may interface with a web service running on a separate computing device (e.g., a cloud server to which computing devices of the project members connect in order to update the steps).

In some embodiments, the system includes enhanced project functions such as collaboration functions to allow project managers to share data with other users before activating a project or task.

Instead of a web site being used, in some embodiments, an app could be used (e.g., a mobile app running on a mobile computing device, such as a smartphone or tablet computing device). In this way, setting up the project could be done from such a mobile computing device. The order in which data is entered could be changed but may yield the same result. Also, since this is a process manager, the software and app can be modified to fit the requirements to specific industries such as the auto industry, construction industry, home use, etc.

Any company or person that needs to follow a specific process could use the process and/or system of the present disclosure. For example, any person with a list of tasks, process, or a project could use the system of the present disclosure to help manage other parties to complete their goals or when a project has steps/task that are depended on the previous step/task. Project managers, in particular, can use it for immediate updates from parties working on their projects.

Additionally, the software for the system could be used for reasons beyond project management. For instance, the system of some embodiments may be used to send homework assignments home with students and showing when the homework was completed. As another example, the software for the system may be deployed and used by installers to help inform customers the time at which a tech will be on site to install a product or system.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

FIG. 5 conceptually illustrates an electronic system 500 with which some embodiments of the invention are implemented. The electronic system 500 may be a computer, phone, PDA, or any other sort of electronic device. Such an electronic system includes various types of computer readable media and interfaces for various other types of computer readable media. Electronic system 500 includes a bus 505, processing unit(s) 510, a system memory 515, a read-only 520, a permanent storage device 525, input devices 530, output devices 535, and a network 540.

The bus 505 collectively represents all system, peripheral, and chipset buses that communicatively connect the numerous internal devices of the electronic system 500. For instance, the bus 505 communicatively connects the processing unit(s) 510 with the read-only 520, the system memory 515, and the permanent storage device 525.

From these various memory units, the processing unit(s) 510 retrieves instructions to execute and data to process in order to execute the processes of the invention. The processing unit(s) may be a single processor or a multi-core processor in different embodiments.

The read-only-memory (ROM) 520 stores static data and instructions that are needed by the processing unit(s) 510 and other modules of the electronic system. The permanent storage device 525, on the other hand, is a read-and-write memory device. This device is a non-volatile memory unit that stores instructions and data even when the electronic system 500 is off. Some embodiments of the invention use a mass-storage device (such as a magnetic or optical disk and its corresponding disk drive) as the permanent storage device 525.

Other embodiments use a removable storage device (such as a floppy disk or a flash drive) as the permanent storage device 525. Like the permanent storage device 525, the system memory 515 is a read-and-write memory device. However, unlike storage device 525, the system memory 515 is a volatile read-and-write memory, such as a random access memory. The system memory 515 stores some of the instructions and data that the processor needs at runtime. In some embodiments, the invention's processes are stored in the system memory 515, the permanent storage device 525, and/or the read-only 520. For example, the various memory units include instructions for processing appearance alterations of displayable characters in accordance with some embodiments. From these various memory units, the processing unit(s) 510 retrieves instructions to execute and data to process in order to execute the processes of some embodiments.

The bus 505 also connects to the input and output devices 530 and 535. The input devices enable the user to communicate information and select commands to the electronic system. The input devices 530 include alphanumeric keyboards and pointing devices (also called “cursor control devices”). The output devices 535 display images generated by the electronic system 500. The output devices 535 include printers and display devices, such as cathode ray tubes (CRT) or liquid crystal displays (LCD). Some embodiments include devices such as a touchscreen that functions as both input and output devices.

Finally, as shown in FIG. 5, bus 505 also couples electronic system 500 to a network 540 through a network adapter (not shown). In this manner, the computer can be a part of a network of computers (such as a local area network (“LAN”), a wide area network (“WAN”), or an intranet), or a network of networks (such as the Internet). Any or all components of electronic system 500 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIG. 1 conceptually illustrates a process in which the specific operations of this process may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which when executed by at least one processing unit of a computing device for manages concurrent steps in a process and communicates attributes of the steps to project members associated with the process, said program comprising sets of instructions for:
creating a project comprising a project name, a project date, a project location, a set of project steps, a start time, a set of tasks for completing the steps of the project, and a set of project member information associated with team members assigned particular tasks to complete for the project;
activating the project;
identifying when each task in the set of tasks is completed;
transmitting project updates to one or more team members for each identified task that is completed, to one or more team members of the projects;
marking the project as completed when all tasks in the set of tasks are completed; and
transmitting a final report for the completed project to one or more team members.

2. The non-transitory computer readable medium of claim 1, wherein the program further comprises a set of instruction for receiving data specifying the set of project steps, the start time, the set of tasks for completing the steps of the project, and the set of project member information;

3. The non-transitory computer readable medium of claim 1, wherein the program further comprises a set of instruction for receiving a set of logon information from a computing device for logging a user onto a project management system at a particular web page.

4. The non-transitory computer readable medium of claim 3, wherein user is a particular team member associated with the computing device.

5. The non-transitory computer readable medium of claim 4, wherein the program further comprises a set of instruction for displaying an account view associated with the particular team member, said account view including personal account information comprising a user name associated with the particular team member, an address associated with the particular team member, a phone number associated with the particular team member, an email address associated with the particular team member, and a summary of project data associated with the particular team member.

6. The non-transitory computer readable medium of claim 1, wherein the program further comprises a set of instruction for receiving input to add a project, wherein said input comprises the project name, the project date, the project start time, and the project location.

7. The non-transitory computer readable medium of claim 6, wherein the set of instructions for creating the project comprises a set of instructions for using the received project input to create the project.

8. The non-transitory computer readable medium of claim 1, wherein the set of instructions for identifying comprises a set of instructions for receiving a set of project task completion data.

9. The non-transitory computer readable medium of claim 1, wherein said team members comprises a responsible team member and a team member to be notified upon completion of a project task.

10. The non-transitory computer readable medium of claim 9, wherein the set of instructions for transmitting project updates comprises a set of instructions for transmitting a particular project update to at least one of a smartphone communication device and an email address of the team member to be notified upon completion of a particular project task.
